(19) United States
(12) Patent Application Publication
(10) Pub. No.: US 2023/0267750 A1
(43) Pub. Date: Aug. 24, 2023

(54) VEHICLE PARKING VIOLATION DETECTION

(71) Applicant: ELM, Riyadh (SA)

(72) Inventors: Thariq Khalid KADAVIL, Riyadh (SA); Mohammed Yahya HAKAMI, Riyadh (SA); Syed Adnan YUSUF, Riyadh (SA); Riad SOUISSI, Riyadh (SA); Syed Salman ALAM, Riyadh (SA)

(73) Assignee: ELM, Riyadh (SA)

(21) Appl. No.: 17/835,404

(22) Filed: Jun. 8, 2022

Related U.S. Application Data
(60) Provisional application No. 63/311,644, filed on Feb. 18, 2022.

(51) Int. Cl. G06V 20/58; G06V 10/778; G06V 10/82

(52) U.S. Cl. CPC G06V 20/586; G06V 10/7784; G06V 20/584; G06V 10/82

(57) ABSTRACT

An Edge encapsulated method and system for real-time detection of a double parking vehicle blocking parked vehicles by capturing images using a mounted monocular camera then processing using two Semi-Supervised Object Detection (sSOD) stages, that is trained with partly labeled and mostly unlabeled data to optimize the model parameters for the detection problem, gathered by capturing video from moving vehicle passing through multiple different vehicle types and parking systems with unconfined location.

### CROSS-REFERENCES TO RELATED APPLICATIONS

The present application claims priority to U.S. Provisional Application No. 63/311,644, filed Feb. 18, 2022, which is incorporated herein by reference in its entirety for all purposes.

### BACKGROUND

### Field of the Disclosure

The present disclosure is directed to automated detection of vehicle status based on image data.

### Description of the Related Art

The “background” description provided herein is for the purpose of generally presenting the context of the disclosure. Work of the presently named inventors, to the extent it is described in the background section, as well as aspects of the description which may not otherwise qualify as prior art at the time of filing, are neither expressedly or impliedly admitted as prior art against the present disclosure.

Parking violations can cause logistical issues and present public safety risks. Parking violations include, but are not limited to, double parking, parking in a non-parking spot, parking by a fire hydrant, parking outside of the boundaries of a parking spot, etc. Detecting and recording parking violations has typically been a manual process involving security or police staff who regularly patrol an area in order to identify cars that are parked illegally. Manual methods can be inefficient and subjective and are also difficult to scale with growing car usage and urban areas. Automated solutions for detecting parking violations such as double parking usually use stationary cameras mounted in fixed positions. For example, an automated system may use a camera installed at a height above the street to capture a bird's eye view of vehicles. However, the detection capabilities of such a system are limited to the view of the camera. A camera that maximizes field of view may sacrifice image quality, which hinders accurate detection of parking violation, especially in crowded areas. A stationary camera is most effective in an open space such as a parking lot, while parking violations such as double parking can occur at curbside locations. Additionally, stationary cameras may have fixed installation or maintenance costs, which cause the cost of the system to increase proportionally with the number of cameras installed in an area. As the number of vehicles worldwide increases and urban areas grow more crowded, there is a need for an automated system that can accurately detect parking violations over a large area and inform further action.

### SUMMARY

According to an embodiment, the present disclosure relates to a method for automated detection of parking violations, including: capturing image data using an edge device equipped with a camera, wherein the image data includes a plurality of frames, identifying, using a first semi-supervised learning model, at least one vehicle in the image data and a position of the at least one vehicle in the image data, identifying, using a second semi-supervised learning model, at least one rear vehicle light on the at least one vehicle, monitoring a status of the at least one rear vehicle light over the plurality of frames, and determining a double parking status of the at least one vehicle based on the position of the at least one vehicle and the status of the at least one rear vehicle light over the plurality of frames.

According to an embodiment, the present disclosure relates to an edge device for automated detection of parking violations, including processing circuitry configured to: capture image data, wherein the image data includes a plurality of frames, identify, using a first semi-supervised learning model, at least one vehicle in the image data and a position of the at least one vehicle in the image data, identify, using a second semi-supervised learning model, at least one rear vehicle light on the at least one vehicle, monitor a status of the at least one rear vehicle light over the plurality of frames, and determine a double parking status of the at least one vehicle based on the position of the at least one vehicle and the status of the at least one rear vehicle light over the plurality of frames.

According to an embodiment, the present disclosure relates to a system for automated detection of parking violations, including at least one camera, a transportation vehicle, and at least one device comprising processing circuitry configured to receive, from the at least one camera, image data comprising a plurality of frames, identify, using a first semi-supervised learning model, at least one vehicle in the image data and a position of the at least one vehicle in the image data, identify, using a second semi-supervised learning model, at least one rear vehicle light on the at least one vehicle, monitor a status of the at least one rear vehicle light over the plurality of frames, determine a double parking status of the at least one vehicle based on the position of the at least one vehicle and the status of the at least one rear vehicle light over the plurality of frames, wherein the at least one device and the at least one camera are transported by the transportation vehicle to capture the image data.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A illustrates a double parking scenario according to an exemplary embodiment of the present disclosure;

FIG. 1B illustrates a double parking scenario according to an exemplary embodiment of the present disclosure;

FIG. 2 illustrates an architecture for training a semi-Supervised Object Detection model according to an exemplary embodiment of the present disclosure;

FIG. 3A illustrates a method for detecting parking violations according to an exemplary embodiment of the present disclosure;

FIG. 3B illustrates a method for detecting a double parking candidate vehicle according to an exemplary embodiment of the present disclosure;

FIG. 3C illustrates a method for confirming double parking violation of a candidate vehicle by verifying whether the vehicle is in waiting state or not according to an exemplary embodiment of the present disclosure;

FIG. 4 illustrates semi-supervised object detection (sSOD) models for detecting double parking vehicle or waiting vehicle according to an exemplary embodiment of the present disclosure;

FIG. 5A illustrates a double parking candidate detected with a bounding box according to an exemplary embodiment of the present disclosure;

FIG. 5B illustrates a waiting vehicle detected with a bounding box according to an exemplary embodiment of the present disclosure;

FIG. 6 illustrates an apparatus for determining double parking violations according to an exemplary embodiment of the present disclosure;

FIG. 7 illustrates a system for verifying double parking according to an exemplary embodiment of the present disclosure;

FIG. 8 is a schematic of a device for performing a method, according to an exemplary embodiment of the present disclosure;

FIG. 9 is a schematic of a hardware system for performing a method, according to an exemplary embodiment of the present disclosure; and

FIG. 10 is a schematic of a hardware configuration of a device for performing a method, according to an exemplary embodiment of the present disclosure.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise. The term “plurality,” as used herein, is defined as two or more than two. The term “another,” as used herein, is defined as at least a second or more. The terms “including” and/or “having,” as used herein, are defined as comprising (i.e., open language). Furthermore, the terms “approximately,” “approximate,” “about,” and similar terms generally refer to ranges that include the identified value within a margin of 20%, 10%, or preferably 5%, and any values therebetween.

Reference throughout this document to “one embodiment,” “certain embodiments,” ‘an embodiment,” “an implementation,” “an example,” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The present disclosure relates to an automated system and method for identifying parking violations in real time. In a preferred embodiment, the present disclosure relates to identifying double parking violations using image processing and recording double parking violations in real time or near real time. The double parking violations can be identified in a parking lot or on a road using semi-supervised object detection models. In one embodiment, the double parking violations can be identified by a device in motion. For example, a device can be mounted in a vehicle wherein the vehicle traverses an area to capture the image data. The device can identify double parking violations from the live feed of image data. In a preferred embodiment, the device can be an edge device. In one aspect, the vehicle can be an edge device. Edge computing can reduce latency and data transmission cost by enabling the edge device to identify the double parking violations without depending on cloud-based connectivity and computation. The data needed to identify the double parking violation can be collected, analyzed, and stored directly at the edge device.

In one embodiment, the device can identify parking violations based on image data collected by a moving vehicle. The device can store data related to the parking violations. For example, the device can store location data (e.g., global positioning system (GPS) coordinates, an address) where a double parking violation is detected. As another example, the device can store a license plate number as identified in the image data. The device can also store a time and date of detection. In one embodiment, the device can be in network communication with a central database or system for storing vehicle information. The device can transmit and/or receive data from the central database regarding the parking violation. For example, the device can transmit the license plate number to the central database and receive vehicle registration information corresponding to the license plate number from the central database. In one embodiment, the device can also store images as evidence of a parking violation. The images can be raw images captured by the device or can be modified images, e.g., images with bounding boxes indicating the parking violation. Bounding boxes can be drawn around an identified object or an object of interest.

In one embodiment, the device can include a camera for capturing the image data. The camera can be a USB camera (e.g., USB 3.0) with a wired connection. In another embodiment, the device can be connected to the camera via a wireless connection, e.g., Bluetooth. The device can include a video buffer, wherein image data from the camera is streamed to the video buffer of the device. In one embodiment, the camera can be a pivoting camera. The camera can swivel along at least one axis to capture the image data. In one embodiment, the motion of the camera can be autonomous or semi-autonomous. For example, the camera can track objects identified in the image data.

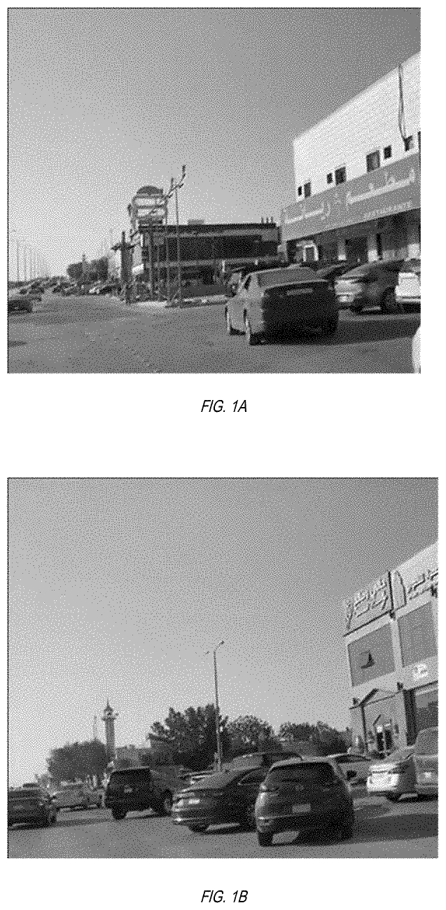

In one embodiment, the present invention can include two semi-supervised object detection (sSOD) models for identifying a double parking violation. Double parking can be defined as illegally standing or parking a vehicle in a road or passageway where vehicles are only supposed to be in motion. Common instances of double parking occur when a vehicle parks on the roadway side of a correctly parked vehicle. The double-parked vehicle blocks the correctly parked vehicle from moving and can also block vehicles in the road. Double parking can also occur in a parking lot, e.g., when a vehicle parks in an area that is not designated as a parking spot. Parked vehicles are usually unoccupied and are not active. Vehicles can include, but are not limited to, cars, vans, and trucks of various sizes and models. FIG. 1A and FIG. 1B illustrate examples of double-parked vehicles. The vehicle in FIG. 1A is blocking parked vehicles in a parking lot from emerging. The vehicle in FIG. 1B is blocking parked vehicles as well as the passageway for vehicles in motion.

The first sSOD (sSOD1) model can detect a double parking candidate from image data provided by the camera. In a real-time application, the image data can be a live video stream from the camera. The second sSOD (sSOD2) model can determine whether the double parking candidate is in a waiting state. A vehicle in a waiting state is not a double-parked vehicle. The determination of a waiting state is necessary to determine whether the double parking candidate is actually committing a parking violation. For example, a car may appear to be double parked but is actually only braking, e.g., at a red light. As another example, a car may appear to be double parked but is actually idling momentarily. The determination of a waiting state requires an analysis of the image data over time rather than a single frame of image data.

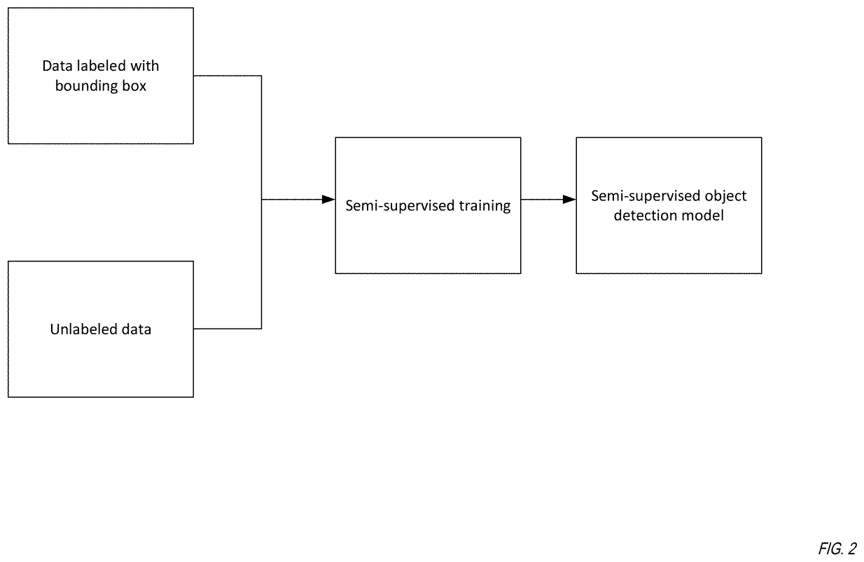

In one embodiment, the semi-supervised object detection models can be trained using semi-supervised learning. Semi-supervised learning refers to a method for training machine learning models using labeled data and unlabeled data, as illustrated in FIG. 2. Labeled data is used in supervised learning to train machine learning models (e.g., object detection models) by providing known input-output pairs and outcomes such that the models can develop a mapping between the input and the output. The mapping can then be applied to test data in order to determine an output from a new input. However, collecting labeled data can be a time-intensive process and can require expert human interaction in order to correctly label the data for training. Creating and processing labeled image data can be especially time-consuming and resource-intensive. In contrast, unsupervised learning uses unlabeled or untagged data to train models via mimicry. A model can be trained on unlabeled data to identify patterns for grouping data into logical segments. Image analysis and object detection are typically done by supervised learning models. However, there are also applications for unsupervised learning models in image analysis. Semi-supervised learning uses a combination of labeled data and unlabeled data, with more unlabeled data than unlabeled data. In one embodiment, the labeled data can be image data labeled with bounding boxes. The bounding boxes can be boxes drawn around an identified object in the image data, e.g., a vehicle. In one embodiment, the bounding box can include a label of the object. Additionally or alternatively, the bounding box can include a statistical measure or a level of confidence in the identified object. Each sSOD model can be trained using labeled data that is relevant to the purpose of the model. For example, the sSOD1 model can be used to identify a vehicle as a double parking candidate. Thus, the sSOD1 model can be trained to differentiate between images of vehicles that are double parked and vehicles that are not double parked.

In one embodiment, the labeled data can comprise 5-10% of the training data and the unlabeled data can comprise 90-95% of the training data. In one embodiment, the labeled data can be used to train the model to create labels for the unlabeled data. The labels can be pseudo labels. In one embodiment, the unlabeled data can be augmented for training. For example, the unlabeled data can include image data that has been scaled, rotated, or shifted. As another example, the unlabeled data can include image data wherein the color data has been modified. In one embodiment, the augmentations can be used to balance the data used for training. In one embodiment, the sSOD models can be trained using a weighted loss function.

In one embodiment, the sSOD models can be trained using knowledge distillation from at least one teacher model. The at least one teacher model can be a trained model used to regularize the training of a student model wherein the student model can have fewer layers than the at least one teacher model. The at least one teacher model can use knowledge distillation to compress and transfer training to the student model. In one embodiment, the distillation can include outputs from each layer of the at least one teacher model as targets for layers of the student model. The student model can then be trained to replicate the outputs of each layer of the at least one teacher model in order to achieve the results of the at least one teacher model using a smaller model. In one embodiment, the student model can be promoted to a teacher model after at least one training iteration. For example, a teacher model can be used to create labels for unlabeled training data. The student model can be trained using the labels created by the teacher model. After one training iteration, the student model can be promoted to a second teacher model. The second teacher model can be used to create labels for the unlabeled training data. A second student model can be trained using the labels created by the second teacher model. In one embodiment, the training and promotion process can be repeated. For example, the promotion of student models to teacher models can be repeated until the third training iteration, wherein the student model trained in the third training iteration can have a desired performance for detecting parking violations. In one embodiment, the teacher model and the student model can be used for an edge computing implementation. Knowledge distillation is a more efficient method for developing model inference and requires fewer computational resources.

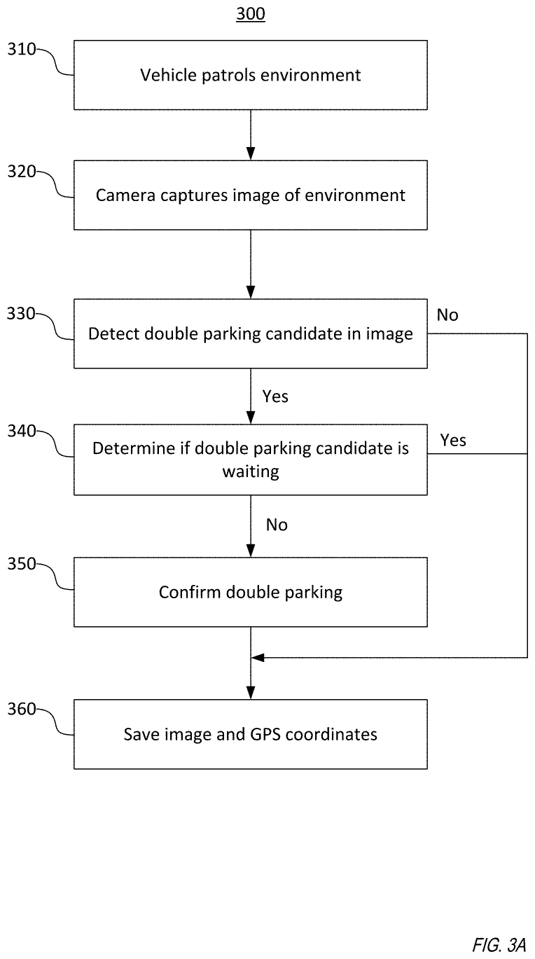

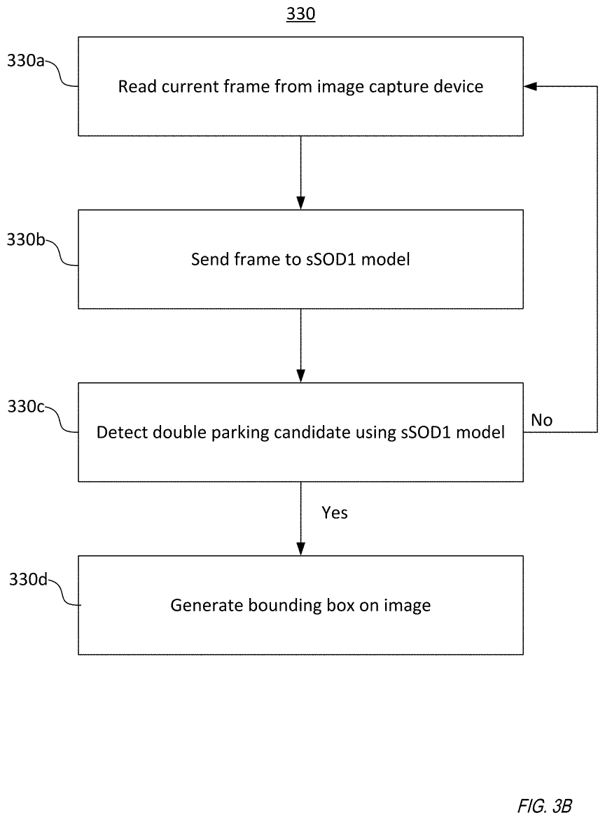

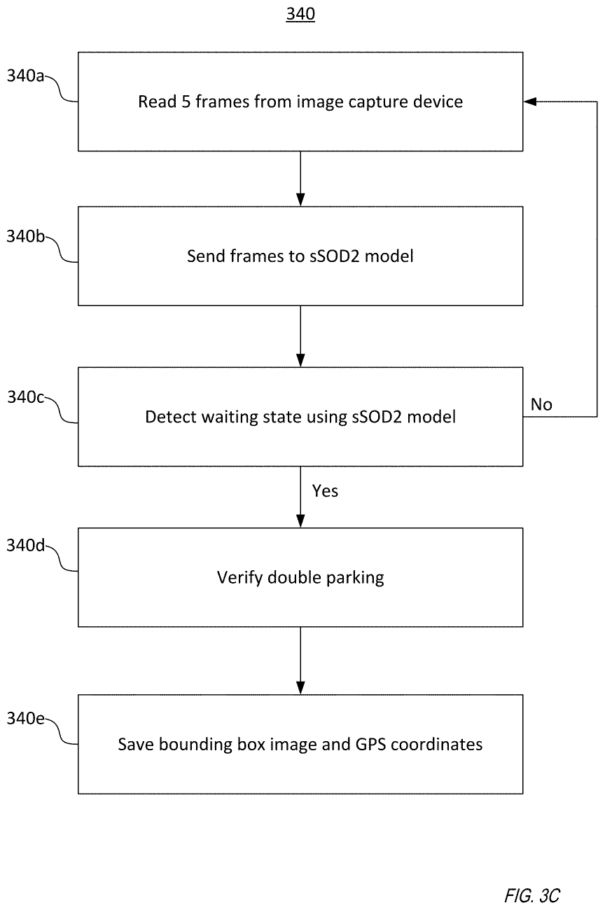

FIG. 3A illustrates a method 300 for detecting parking violations using a vehicle in motion. The vehicle can patrol an environment in step 310 and a camera attached to the vehicle can capture images of the environment in step 320. The images can include a video feed. The camera can be mounted, for example, on top of the vehicle. The sSOD1 model can detect a vehicle that is a double parking candidate in an image in step 330. If a double parking candidate is not identified, the image and the GPS coordinates corresponding to the image are saved. The image can be used for future reference. If the double parking candidate is identified, the sSOD2 model can determine if the double parking candidate is waiting in step 340. If the double parking candidate is waiting, the vehicle is not double-parked. The image is then saved along with the GPS coordinates corresponding to the image. If the double parking candidate is not waiting, the vehicle is confirmed to be double-parked in step 350. The image of the double parking candidate and the GPS coordinates corresponding to the image are then saved in 360. In one embodiment, the image can be saved with bounding boxes.

FIG. 3B illustrates the method 330 for identifying a double parking candidate using the sSOD1 model according to one embodiment of the present invention. A current frame of image data from the image capture device (e.g., the camera) is read in step 330a and sent to the sSOD1 model in step 330b. The sSOD1 model detects a double parking candidate in step 330c. If a double parking candidate is not detected, the sSOD1 model continues to read frames of image data from the image data capture device, as in step 330a. If the double parking candidate is detected, the sSOD1 model can generate a bounding box around the double parking candidate in the image data in step 330d. The bounding box can include, for example, a confidence score. The confidence score can be a value between 0 and 1.

FIG. 3C illustrates the method 340 for determining if a double parking candidate is waiting using the sSOD2 model. In one embodiment, the five frames of image data of the double parking candidate can be read in step 340a and sent to the sSOD2 model in step 340b. In another embodiment, the sSOD2 model can use more or less than five frames of image data. The sSOD2 model can detect a waiting state of the double parking candidate in step 340c. If the double parking candidate is not waiting, the sSOD2 model can continue to read frames of the next double parking candidate. If the double parking candidate is not waiting, the sSOD2 model can verify that the double parking candidate is double-parked in step 340d. The sSOD2 model can then save an image of the vehicle and GPS coordinates corresponding to the image in step 340e. The image of the vehicle can include a bounding box indicating that the vehicle is double-parked.

According to one embodiment, a double parking candidate can be considered a vehicle in a double parking position. For example, a vehicle in the road next to a legally parked vehicle can be a double parking candidate. In one embodiment, the sSOD1 model can identify a vehicle in the image data. In one embodiment, the sSOD1 model can further identify aspects about the environment surrounding the vehicle to determine whether the vehicle is a double parking candidate. For example, the sSOD1 model can identify that the vehicle is on a road. As another example, the sSOD1 model can identify objects in proximity to the vehicle. The objects in proximity can include, but are not limited to, additional vehicles, sidewalks, road markings (e.g., lane indicators, crosswalks), signs, and/or pedestrians. The sSOD1 model can determine a position of the vehicle based on the identified objects in proximity to the vehicle. In one embodiment, a vehicle can be identified as a double parking candidate based on the presence and proximity of a blocked vehicle. A double-parked vehicle can obstruct a vehicle that is parked legally, e.g., in a parking spot on the side of a road. The double-parked vehicle can be parked next to a legally parked vehicle and block the legally parked vehicle from moving or accessing the road. In one embodiment, a vehicle can be identified as a double parking candidate by localizing the vehicle relative to a second vehicle. For example, the back of the vehicle can be localized relative to the front, the back, or a side of the second vehicle. The vehicle can be identified as a double parking candidate if the back of the vehicle is aligned with the back of the second vehicle. In one embodiment, the vehicle can be identified as a double parking candidate if the vehicle is adjacent to the second vehicle even if the second vehicle is ahead of or behind the vehicle. For example, the back of the vehicle may be aligned with the front or the side of the second vehicle. In one embodiment, the sSOD1 model can determine whether a vehicle is stationary based on the image data. A vehicle in motion may be blurry or appear distorted in a single frame of image data, while a stationary vehicle may not be blurry or distorted.

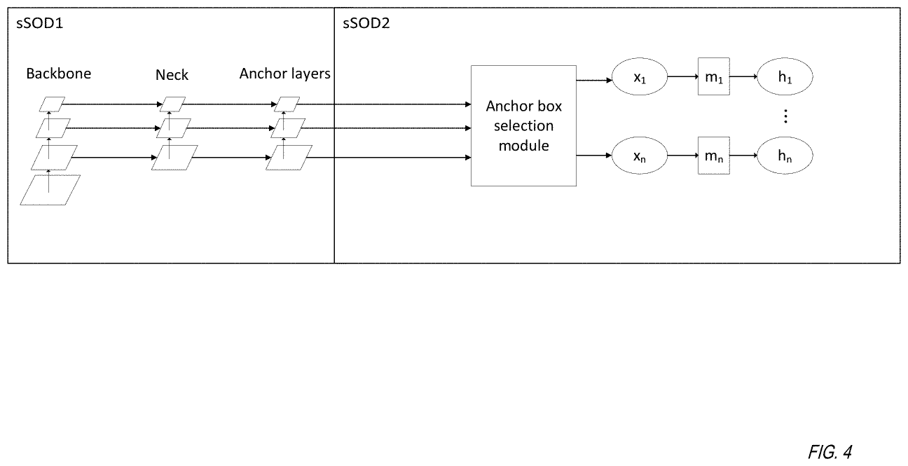

FIG. 4 illustrates an architecture of the sSOD1 model and the sSOD2 model. The sSOD1 model can be a real-time object detection model including a backbone, a neck, and at least one anchor layer. The backbone of the sSOD1 model can be used to identify image features in the image data. In one embodiment, the backbone can include at least one convolutional neural network (CNN) for image analysis. The at least one CNN can include multiple layers, including, but not limited to, at least one convolutional layer and at least one fully-connected layer. In one embodiment, the at least one CNN can include pooling layers. The at least one CNN can be designed to optimize the processing capabilities of an edge device. In one embodiment, the backbone can include a cross stage partial network, a MobileNet network, and/or an EfficientNet network.

The features identified by the at least one CNN can be compressed in the backbone. In an object detection model, the neck of the model can be used for feature aggregation and extraction. Features identified by the backbone of the model can be combined and mixed in the neck for anchor-based detection. In one embodiment, the backbone and the neck can be connected for multiscale feature detection to introduce size tolerance for objects detected by the model. Vehicles of varying sizes can thus be detected due to the multiscale detection. In one embodiment, features identified by a layer in the backbone can be passed to a layer in the neck. In one embodiment, the neck of the sSOD1 model can include a feature pyramid network. A feature pyramid network can scale a single input image and create proportional feature maps for each scaled version of the input image. The feature pyramid network can eliminate or reduce vehicle size biases in identifying various models and types of vehicles as double parking candidates. The neck can therefore identify double parking candidates based on adjacent vehicles regardless of the size of the candidate and the adjacent vehicle or vehicles. In one embodiment, the neck can include a path aggregation network. The final stage of the sSOD1 model can include at least one anchor layer. The at least one anchor layer can identify double parking candidates using anchor boxes. The anchor boxes can be predefined bounding boxes with set dimensions (height and width) that define an object of interest (e.g., a vehicle). The anchor boxes can be layered over the feature maps created by the feature pyramid network so that the sSOD1 model can determine whether the identified features in the image are double parking candidates. In one embodiment, the sSOD1 model can include three anchor layers. Each of the anchor layers can use different grid sizes to overlay the anchor boxes over an image. In one embodiment, the sSOD1 model can identify the double parking candidate using the anchor boxes. In one embodiment, a single image can include multiple double parking candidates. The sSOD1 model can draw bounding boxes around the double parking candidates as identified by the at least one anchor layer.

In one embodiment, the images with bounding boxes can be inputs to the sSOD2 model. In one embodiment, the images of the detected double parking candidates defined by the bounding boxes can be used as the input to the sSOD2 model. The sSOD2 model can include an anchor box selection module. The anchor box selection module can filter out bounding boxes with low model confidence and prioritize processed image information. In one embodiment, non-max suppression can be used for anchor box selection. The images selected by the anchor box selection module can be used as inputs into a memory module wherein the memory module can determine whether the double parking candidates are in a waiting state. The memory module can be used to identify a relationship between frames over time in order to identify whether a double parking candidate is in a waiting state. In one embodiment, each bounding box selected by the anchor box selection module can be evaluated separately by the memory module. The bounding boxes can be evaluated sequentially or in parallel by separate networks, as illustrated in FIG. 4.

The memory module can take process an input image using a memory network. In one embodiment, the memory network can be a parameter-tuned memory network. In one embodiment, the memory network can be a parametric neural network. In one embodiment, the memory network can use linear combinations of semantic features (x) within a memory module (m) to identify the double parking candidate as double parking or as waiting in an output image (h). The semantic features (x) can be identified for each frame of image data. In embodiment, the memory module (m) can use hyperparameters. The hyperparameters can be model hyperparameters and/or algorithm hyperparameters. In one embodiment, the output image (h) can include a bounding box and/or an identifying label. In one embodiment, the memory module can include a long short term memory network and/or transformer. The memory module can output an output image h, wherein the output image h is an image of the double parking candidate with a bounding box identifying the double parking candidate as double parking or as waiting.

In one embodiment, the memory module can analyze indicator lights on a vehicle, such as rear lights and/or front lights, to identify the waiting state. The memory module can identify and analyze the indicator lights over a plurality of frames, e.g., five frames. In one embodiment, the memory module can store state information about the state of the double parking candidate in each frame as indicated by the indicator lights. The state of the double parking candidate over time can be used to determine whether the double parking candidate is in a waiting state. A waiting state can refer to a vehicle that is momentarily waiting in a location rather than fully parked. For example, a vehicle that is idling may have rear hazard lights on, which are flashing lights. The flashing of the hazard lights may be captured by the camera over a plurality of frames, as identified by the memory module. The presence of the hazard lights in at least one of the frames can indicate that the double parking candidate is waiting and is not actually parked. As another illustrative example, a double parking candidate may be only stopped momentarily, e.g., at a red light, rather than parked. In this scenario, the rear brake lights of the vehicle would be on until the vehicle is in motion. The memory module can identify that the brake lights are on over a plurality of frames and that the vehicle is waiting rather than parked, even if the vehicle is stationary in the plurality of frames. In contrast, a vehicle that is parked and unoccupied would not have rear lights on in any of the plurality of frames. The vehicle would thus not be in a waiting state because it is parked. In one embodiment, the input images can include bounding boxes drawn around the rear lights and/or other indicator lights.

In one embodiment, the memory module can identify whether the double parking candidate is stationary by determining a location of the double parking candidate in each of the frames of image data. In one embodiment, the sSOD1 model and/or the sSOD2 model can correct for the movement of the camera in determining whether the double parking candidate is stationary and/or waiting. For example, if the camera is moving past the double parking candidate while capturing the images, the location, orientation, and/or position of the double parking candidate may be different in each image. The first sSOD1 model can identify the double parking candidate across each of the images. In one embodiment, the first sSOD1 model can use visual attributes (e.g., color, size, shape, model, make, license plate number, etc.) to verify the double parking candidate across each of the images. In one embodiment, the memory module can use the different angles and views of the double parking candidate to determine if the double parking candidate is in a waiting state.

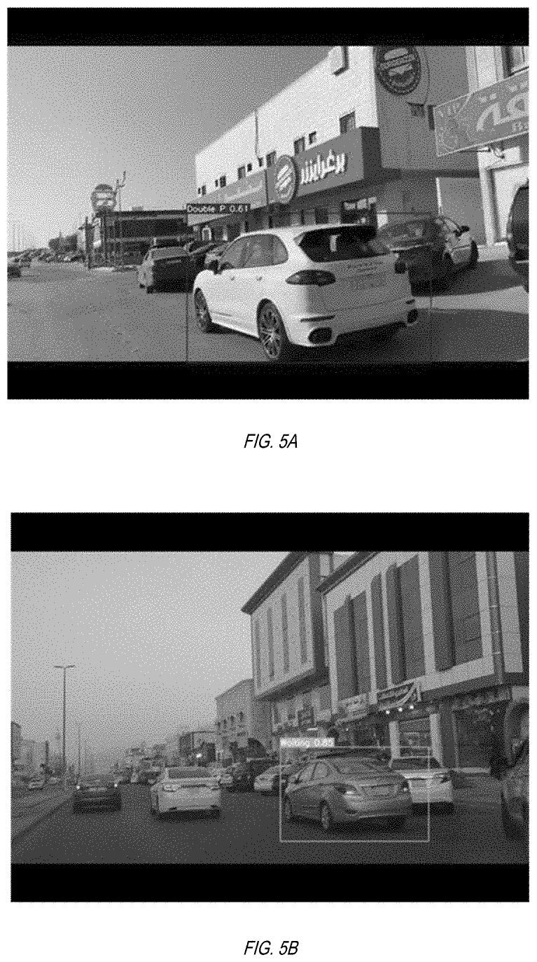

FIG. 5A and FIG. 5B illustrate examples of double parking candidates that have been assessed by the sSOD2 model to determine a waiting state according to one embodiment of the present invention. The vehicles were first identified as double parking candidates by the sSOD1 model. While FIG. 5A and FIG. 5B are single frames, it can be understood that the sSOD2 model can analyze a plurality of frames in order to accurately assess a double parking candidate, as has been described in the present disclosure. FIG. 5A shows a double parking candidate that has been identified as being double-parked by the sSOD2 model. The rear lights of the vehicle are off, which indicates that the vehicle is not in a waiting state and that the vehicle is fully parked. Therefore, the sSOD2 model can draw a bounding box around the vehicle. The bounding box, as illustrated in FIG. 5A, can label the vehicle as double-parked with a confidence value, e.g., 0.61. The confidence value can be a percentage. FIG. 5B shows a double parking candidate that has been identified as waiting by the sSOD2 model. The rear lights of the vehicle are on, which indicates that the vehicle is only momentarily stopped in a waiting state rather than being parked. The sSOD2 model can draw a bounding box around the vehicle. The bounding box can label the vehicle as waiting with a confidence value, e.g., 0.85. In one embodiment, the sSOD2 model can update the identification of the waiting state and/or the confidence value of identification. For example, additional images can provide more data for an updated assessment of a double parking candidate.

In one embodiment, the method for detecting parking violations can include transmitting and/or receiving data about a parking violation. For example, an image of a double-parked vehicle can be transmitted over a communication network to a central database for tracking vehicle information. The central database can be a security database, a law enforcement database, a government database, etc. In one embodiment, data about the parking violation including, but not limited to, a labeled image, a time, a date, a location, a duration, a severity, a description of the violation, vehicle information (e.g., a size, a color, a make, a model, a license plate number), and/or environmental information (e.g., a type of environment, surrounding vehicles, weather conditions, etc.) can be transmitted to the central database. In one embodiment, the data about the parking violation can be used to update a vehicle record. In one embodiment, the vehicle record can include driver or owner information. In one embodiment, an edge device can access the vehicle record. In one embodiment, the method for detecting parking violations can include making a decision regarding the parking violation. For example, the parking violation may result in a ticket, a fine, or a strike on a driver record. The consequence of the parking violation may depend on any combination of factors related to the violation and/or the vehicle.

In one embodiment, the method for detecting parking violations using image data can be executed on an edge device. Edge computing enables data processing to occur where data is collected, which is especially helpful for real-time analysis of a stream of video data, as in the present invention. In one embodiment, the edge device can be part of a network of edge devices. Each device in the network of edge devices can execute the method for identifying double-parked vehicles independently. In one embodiment, each edge device in the network of edge devices can transmit data across the network. The data can include image data and/or parking violation data. In one embodiment, the saved images and GPS coordinates for each edge device can be distributed across the network of edge devices. Each edge device can access the same set of saved images and GPS coordinates, as well as additional relevant information corresponding to each saved image. In one embodiment, each edge device can update images of the same vehicle to reduce redundancy. In one embodiment, each edge device can update the sSOD1 model and/or the sSOD2 model, e.g., retrain the sSOD1 model and/or the sSOD2 model. Changes to the models can be propagated across the network of edge devices to maximize the accuracy of each edge device. In one embodiment, the sSOD1 model and/or the sSOD2 model can be quantized to reduce computing power requirements. In one embodiment, quantization can be used to approximate weights in a model and reduce model size and memory consumption. For example, weights can be quantized as integers, e.g., in an INT8 data type. In one embodiment, quantization can be implemented in a model that supports edge implementations, e.g., TensorRT, TensorFlow Lite. In one embodiment, unused neurons in a network can be pruned from a model for faster inference.

In one embodiment, the edge device can be mounted on a vehicle, wherein the vehicle can patrol an environment to capture image data. In one embodiment, the edge device can be embedded in the vehicle. For example, the vehicle itself can be an edge device. A vehicle can include, but is not limited to, a car, a van, a truck, a rover, a cart, etc. In one embodiment, the vehicle can be an autonomous vehicle or a semi-autonomous vehicle. A system that can be operable from a moving vehicle can greatly expand the coverage area of detection without increased variable cost. Additionally, the automated method described herein does not require a driver or operator to observe the parking violations, which results in more efficient and standardized identification of parking violations.

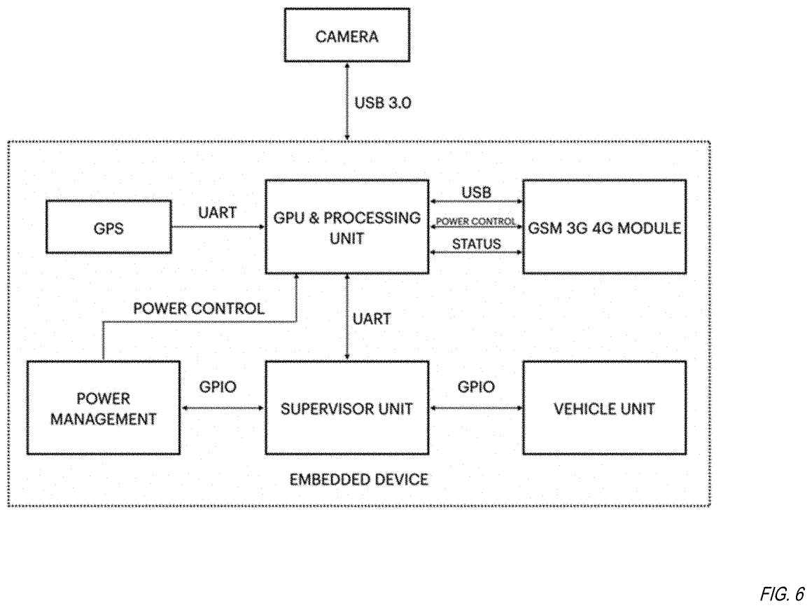

FIG. 6 illustrates an apparatus for determining double parking violations according to an exemplary embodiment of the present disclosure. In one embodiment, the apparatus can be an embedded device according to one embodiment of the present invention. The device can be embedded into the vehicle unit. In one embodiment, the embedded device can include a GPS unit to determine a location of the captured images. The embedded device can be connected to a cellular and/or data communication network. In one embodiment, the embedded device can include 3G, 4G, and 5G capabilities for connecting to the cellular and/or data communication network.

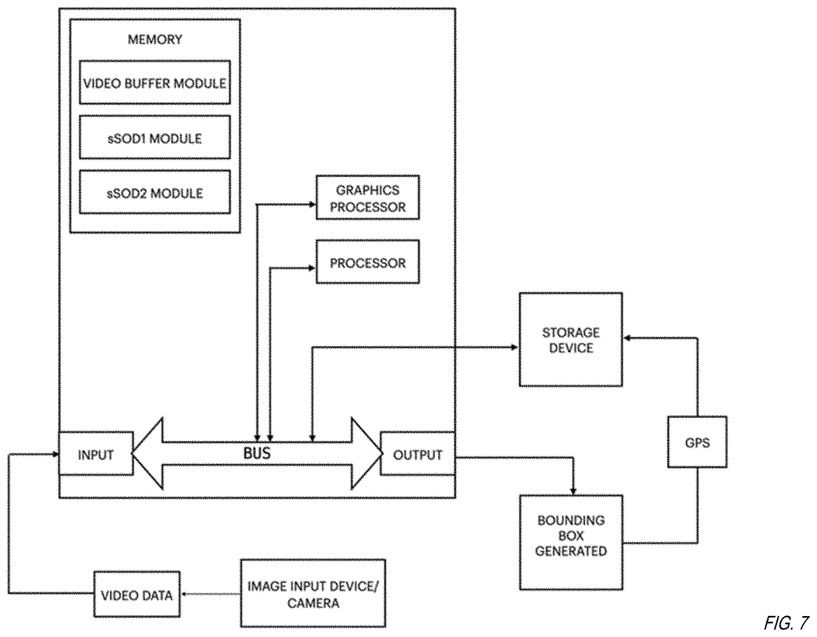

FIG. 7 illustrates a system for verifying double parking according to an exemplary embodiment of the present disclosure. The system can include a device in communication with an image input device. The image input device can capture video data and transmit the video data to the device over a wired or wireless connection. The device can save an image of the double parking candidate with a bounding box generated in the image. The image with the generated bounding box can be combined with GPS coordinates for storage in a storage device.

Embodiments of the subject matter and the functional operations described in this specification can be implemented by digital electronic circuitry, in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of data processing apparatus. The computer storage medium can be a machine-readable storage device, a machine-readable storage substrate, a random or serial access memory device, or a combination of one or more of them.

The term “data processing apparatus” refers to data processing hardware and may encompass all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, Subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA an ASIC.

Computers suitable for the execution of a computer program include, by way of example, general or special purpose microprocessors or both, or any other kind of central processing unit. Generally, a CPU will receive instructions and data from a read-only memory or a random access memory or both. Elements of a computer are a CPU for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

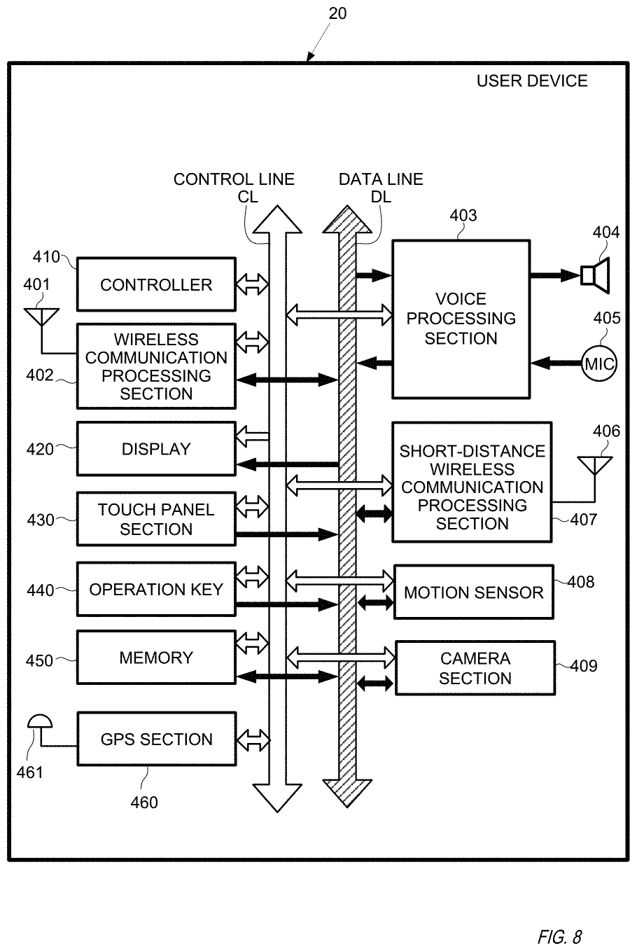

Electronic user device 20 shown in FIG. 8 can be an example of an edge device for implementing embodiments of the present disclosure. For example, the electronic user device 20 can be an example of the embedded device illustrated in FIG. 6. In an embodiment, the electronic user device 20 may be a smartphone. However, the skilled artisan will appreciate that the features described herein may be adapted to be implemented on other devices (e.g., a laptop, a tablet, a server, an e-reader, a camera, a navigation device, etc.). The exemplary user device 20 of FIG. 8 includes processing circuitry, as discussed above. The processing circuitry includes one or more of the elements discussed next with reference to FIG. 8. The electronic user device 20 may include other components not explicitly illustrated in FIG. 8 such as a CPU, GPU, frame buffer, etc. The electronic user device 20 includes a controller 410 and a wireless communication processor 402 connected to an antenna 401. A speaker 404 and a microphone 405 are connected to a voice processor 403.

The controller 410 may include one or more processors/processing circuitry (CPU, GPU, or other circuitry) and may control each element in the user device 20 to perform functions related to communication control, audio signal processing, graphics processing, control for the audio signal processing, still and moving image processing and control, and other kinds of signal processing. The controller 410 may perform these functions by executing instructions stored in a memory 450. Alternatively or in addition to the local storage of the memory 450, the functions may be executed using instructions stored on an external device accessed on a network or on a non-transitory computer readable medium.

The memory 450 includes but is not limited to Read Only Memory (ROM), Random Access Memory (RAM), or a memory array including a combination of volatile and non-volatile memory units. The memory 450 may be utilized as working memory by the controller 410 while executing the processes and algorithms of the present disclosure. Additionally, the memory 450 may be used for long-term storage, e.g., of image data and information related thereto.

The user device 20 includes a control line CL and data line DL as internal communication bus lines. Control data to/from the controller 410 may be transmitted through the control line CL. The data line DL may be used for transmission of voice data, displayed data, etc.

The antenna 401 transmits/receives electromagnetic wave signals between base stations for performing radio-based communication, such as the various forms of cellular telephone communication. The wireless communication processor 402 controls the communication performed between the user device 20 and other external devices via the antenna 401. For example, the wireless communication processor 402 may control communication between base stations for cellular phone communication.

The speaker 404 emits an audio signal corresponding to audio data supplied from the voice processor 403. The microphone 405 detects surrounding audio and converts the detected audio into an audio signal. The audio signal may then be output to the voice processor 403 for further processing. The voice processor 403 demodulates and/or decodes the audio data read from the memory 450 or audio data received by the wireless communication processor 402 and/or a short-distance wireless communication processor 407. Additionally, the voice processor 403 may decode audio signals obtained by the microphone 405.

The exemplary user device 20 may also include a display 420, a touch panel 430, an operation key 440, and a short-distance communication processor 407 connected to an antenna 406. The display 420 may be a Liquid Crystal Display (LCD), an organic electroluminescence display panel, or another display screen technology. In addition to displaying still and moving image data, the display 420 may display operational inputs, such as numbers or icons which may be used for control of the user device 20. The display 420 may additionally display a GUI for a user to control aspects of the user device 20 and/or other devices. Further, the display 420 may display characters and images received by the user device 20 and/or stored in the memory 450 or accessed from an external device on a network. For example, the user device 20 may access a network such as the Internet and display text and/or images transmitted from a Web server.

The touch panel 430 may include a physical touch panel display screen and a touch panel driver. The touch panel 430 may include one or more touch sensors for detecting an input operation on an operation surface of the touch panel display screen. The touch panel 430 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus may include a conductive material at least at the tip of the stylus such that the sensors included in the touch panel 430 may detect when the stylus approaches/contacts the operation surface of the touch panel display (similar to the case in which a finger is used for the touch operation).

In certain aspects of the present disclosure, the touch panel 430 may be disposed adjacent to the display 420 (e.g., laminated) or may be formed integrally with the display 420. For simplicity, the present disclosure assumes the touch panel 430 is formed integrally with the display 420 and therefore, examples discussed herein may describe touch operations being performed on the surface of the display 420 rather than the touch panel 430. However, the skilled artisan will appreciate that this is not limiting.

For simplicity, the present disclosure assumes the touch panel 430 is a capacitance-type touch panel technology. However, it should be appreciated that aspects of the present disclosure may easily be applied to other touch panel types (e.g., resistance-type touch panels) with alternate structures. In certain aspects of the present disclosure, the touch panel 430 may include transparent electrode touch sensors arranged in the X-Y direction on the surface of transparent sensor glass.

The touch panel driver may be included in the touch panel 430 for control processing related to the touch panel 430, such as scanning control. For example, the touch panel driver may scan each sensor in an electrostatic capacitance transparent electrode pattern in the X-direction and Y-direction and detect the electrostatic capacitance value of each sensor to determine when a touch operation is performed. The touch panel driver may output a coordinate and corresponding electrostatic capacitance value for each sensor. The touch panel driver may also output a sensor identifier that may be mapped to a coordinate on the touch panel display screen. Additionally, the touch panel driver and touch panel sensors may detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. For example, in an embodiment, the touch panel 430 may detect a position of a user's finger around an edge of the display panel 420 (e.g., gripping a protective case that surrounds the display/touch panel). Signals may be transmitted by the touch panel driver, e.g. in response to a detection of a touch operation, in response to a query from another element based on timed data exchange, etc.

The touch panel 430 and the display 420 may be surrounded by a protective casing, which may also enclose the other elements included in the user device 20. In an embodiment, a position of the user's fingers on the protective casing (but not directly on the surface of the display 420) may be detected by the touch panel 430 sensors. Accordingly, the controller 410 may perform display control processing described herein based on the detected position of the user's fingers gripping the casing. For example, an element in an interface may be moved to a new location within the interface (e.g., closer to one or more of the fingers) based on the detected finger position.

Further, in an embodiment, the controller 410 may be configured to detect which hand is holding the user device 20, based on the detected finger position. For example, the touch panel 430 sensors may detect a plurality of fingers on the left side of the user device 20 (e.g., on an edge of the display 420 or on the protective casing), and detect a single finger on the right side of the user device 20. In this exemplary scenario, the controller 410 may determine that the user is holding the user device 20 with his/her right hand because the detected grip pattern corresponds to an expected pattern when the user device 20 is held only with the right hand.

The operation key 440 may include one or more buttons or similar external control elements, which may generate an operation signal based on a detected input by the user. In addition to outputs from the touch panel 430, these operation signals may be supplied to the controller 410 for performing related processing and control. In certain aspects of the present disclosure, the processing and/or functions associated with external buttons and the like may be performed by the controller 410 in response to an input operation on the touch panel 430 display screen rather than the external button, key, etc. In this way, external buttons on the user device 20 may be eliminated in lieu of performing inputs via touch operations, thereby improving watertightness.

The antenna 406 may transmit/receive electromagnetic wave signals to/from other external apparatuses, and the short-distance wireless communication processor 407 may control the wireless communication performed between the other external apparatuses. Bluetooth, IEEE 802.11, and near-field communication (NFC) are non-limiting examples of wireless communication protocols that may be used for inter-device communication via the short-distance wireless communication processor 407.

The user device 20 may include a motion sensor 408. The motion sensor 408 may detect features of motion (i.e., one or more movements) of the user device 20. For example, the motion sensor 408 may include an accelerometer to detect acceleration, a gyroscope to detect angular velocity, a geomagnetic sensor to detect direction, a geo-location sensor to detect location, etc., or a combination thereof to detect motion of the user device 20. In an embodiment, the motion sensor 408 may generate a detection signal that includes data representing the detected motion. For example, the motion sensor 408 may determine a number of distinct movements in a motion (e.g., from start of the series of movements to the stop, within a predetermined time interval, etc.), a number of physical shocks on the user device 20 (e.g., a jarring, hitting, etc., of the electronic device), a speed and/or acceleration of the motion (instantaneous and/or temporal), or other motion features. The detected motion features may be included in the generated detection signal. The detection signal may be transmitted, e.g., to the controller 410, whereby further processing may be performed based on data included in the detection signal. The motion sensor 408 can work in conjunction with a Global Positioning System (GPS) section 460. The information of the present position detected by the GPS section 460 is transmitted to the controller 410. An antenna 461 is connected to the GPS section 460 for receiving and transmitting signals to and from a GPS satellite.

The user device 20 may include a camera section 409, which includes a lens and shutter for capturing photographs of the surroundings around the user device 20. In an embodiment, the camera section 409 captures surroundings of an opposite side of the user device 20 from the user. The images of the captured photographs can be displayed on the display panel 420. A memory section saves the captured photographs. The memory section may reside within the camera section 109 or it may be part of the memory 450. The camera section 409 can be a separate feature attached to the user device 20 or it can be a built-in camera feature.

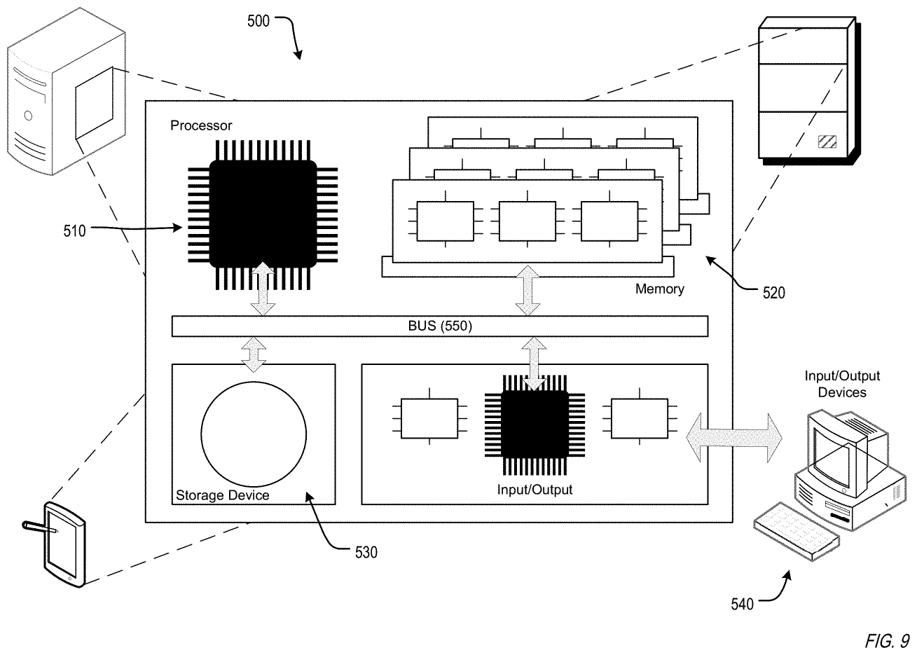

An example of a type of computer is shown in FIG. 9. The computer 500 can be used for the operations described in association with any of the computer-implement methods described previously, according to one implementation. The processing circuitry includes one or more of the elements discussed next with reference to FIG. 9. In FIG. 9, the computer 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the computer 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the computer 500. In one implementation, the storage device 530 is a computer-readable medium. In various different implementations, the storage device 530 may be a floppy disk device, a hard disk device, an optical disk device, or a tape device.

The input/output device 540 provides input/output operations for the computer 500. In one implementation, the input/output device 540 includes a keyboard and/or pointing device. In another implementation, the input/output device 540 includes a display unit for displaying graphical user interfaces.

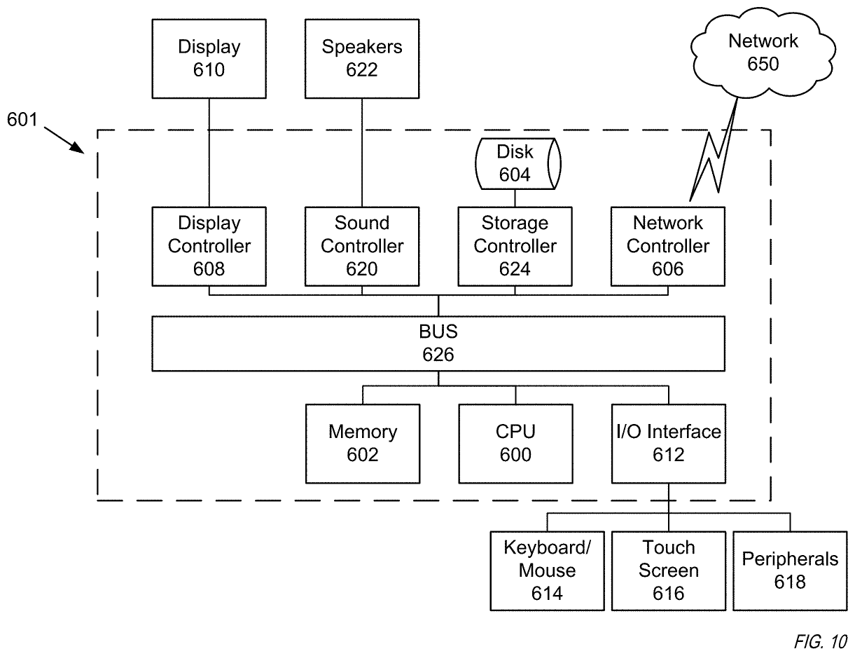

Next, a hardware description of a device 601 according to exemplary embodiments is described with reference to FIG. 10. In FIG. 10, the device 601 includes processing circuitry, as discussed above. The processing circuitry includes one or more of the elements discussed next with reference to FIG. 10. The device 601, may include other components not explicitly illustrated in FIG. 10 such as a CPU, GPU, frame buffer, etc. In FIG. 10, the device 601 includes a CPU 600 which performs the processes described above/below. The process data and instructions may be stored in memory 602. These processes and instructions may also be stored on a storage medium disk 604 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device 601 communicates, such as a server or computer.

Further, the claimed advancements may be provided as a utility application, background daemon, or component of an operating system, or combination thereof, executing in conjunction with CPU 600 and an operating system such as Microsoft Windows, UNIX, Solaris, LINUX, Apple MAC-OS and other systems known to those skilled in the art.

The hardware elements in order to achieve the device 601 may be realized by various circuitry elements, known to those skilled in the art. For example, CPU 600 may be a Xenon or Core processor from Intel of America or an Opteron processor from AMD of America, or may be other processor types that would be recognized by one of ordinary skill in the art. Alternatively, the CPU 600 may be implemented on an FPGA, ASIC, PLD or using discrete logic circuits, as one of ordinary skill in the art would recognize. Further, CPU 600 may be implemented as multiple processors cooperatively working in parallel to perform the instructions of the processes described above.

The device 601 in FIG. 10 also includes a network controller 606, such as an Intel Ethernet PRO network interface card from Intel Corporation of America, for interfacing with network 650. As can be appreciated, the network 650 can be a public network, such as the Internet, or a private network such as an LAN or WAN network, or any combination thereof and can also include PSTN or ISDN sub-networks. The network 650 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The device 601 further includes a display controller 608, such as a NVIDIA GeForce GTX or Quadro graphics adaptor from NVIDIA Corporation of America for interfacing with display 610, such as an LCD monitor. A general purpose I/O interface 612 interfaces with a keyboard and/or mouse 614 as well as a touch screen panel 616 on or separate from display 610. General purpose I/O interface also connects to a variety of peripherals 618 including printers and scanners.

A sound controller 620 is also provided in the device 601 to interface with speakers/microphone 622 thereby providing sounds and/or music.

The general purpose storage controller 624 connects the storage medium disk 604 with communication bus 626, which may be an ISA, EISA, VESA, PCI, or similar, for interconnecting all of the components of the device 601. A description of the general features and functionality of the display 610, keyboard and/or mouse 614, as well as the display controller 608, storage controller 624, network controller 606, sound controller 620, and general purpose I/O interface 612 is omitted herein for brevity as these features are known.

While this specification contains many specific implementation details, these should not be construed as limitations on the scope of what may be claimed, but rather as descriptions of features that may be specific to particular embodiments.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Thus, the foregoing discussion discloses and describes merely exemplary embodiments of the present disclosure. As will be understood by those skilled in the art, the present disclosure may be embodied in other specific forms without departing from the spirit thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

1. A method for automated detection of parking violations, comprising:
capturing image data using an edge device equipped with a camera, wherein the image data includes a plurality of frames;
identifying, using a first semi-supervised learning model, at least one vehicle in the image data and a position of the at least one vehicle in the image data;
identifying, using a second semi-supervised learning model, at least one rear vehicle light on the at least one vehicle;
monitoring a status of the at least one rear vehicle light over the plurality of frames; and
determining a double parking status of the at least one vehicle based on the position of the at least one vehicle and the status of the at least one rear vehicle light over the plurality of frames.

2. The method of claim 1, wherein the edge device is a transportation vehicle and further comprising the transportation vehicle traversing an area for automated detection of the parking violations.

3. The method of claim 1, further comprising training the first semi-supervised learning model and the second semi-supervised learning model using unlabeled image data.

4. The method of claim 1, wherein the first semi-supervised learning model and the second semi-supervised learning model include at least one neural network.

5. The method of claim 1, wherein the first semi-supervised learning model and the second semi-supervised learning model are quantized.

6. The method of claim 1, further comprising the edge device determining a location of the at least one vehicle and associating the location of the at least one vehicle with the double parking status of the at least one vehicle.

7. The method of claim 1, further comprising the edge device saving the image data and the double parking status of the at least one vehicle.

8. An edge device for automated detection of parking violations, comprising:
processing circuitry configured to:
capture image data, wherein the image data includes a plurality of frames;
identify, using a first semi-supervised learning model, at least one vehicle in the image data and a position of the at least one vehicle in the image data;
identify, using a second semi-supervised learning model, at least one rear vehicle light on the at least one vehicle;
monitor a status of the at least one rear vehicle light over the plurality of frames; and
determine a double parking status of the at least one vehicle based on the position of the at least one vehicle and the status of the at least one rear vehicle light over the plurality of frames.

9. The edge device of claim 8, wherein the edge device is a transportation vehicle and wherein the transportation vehicle is mobile.

10. The edge device of claim 8, wherein the edge device is a mobile device.

11. The edge device of claim 8, wherein the first semi-supervised learning model and the second semi-supervised learning model are quantized.

12. The edge device of claim 8, wherein the processing circuitry is further configured to modify the image data.

13. The edge device of claim 8, wherein the processing circuitry is further configured to determine a location of the at least one vehicle and associate the location of the at least one vehicle with the double parking status of the at least one vehicle.

14. The edge device of claim 8, wherein the processing circuitry is further configured to save the image data and the double parking status.

15. A system for automated detection of parking violations, comprising:
at least one camera;
a transportation vehicle; and
at least one device comprising processing circuitry configured to
receive, from the at least one camera, image data comprising a plurality of frames;
identify, using a first semi-supervised learning model, at least one vehicle in the image data and a position of the at least one vehicle in the image data;
identify, using a second semi-supervised learning model, at least one rear vehicle light on the at least one vehicle;
monitor a status of the at least one rear vehicle light over the plurality of frames; and
determine a double parking status of the at least one vehicle based on the position of the at least one vehicle and the status of the at least one rear vehicle light over the plurality of frames;
wherein the at least one device and the at least one camera are transported by the transportation vehicle to capture the image data.

16. The system of claim 15, wherein the at least one device is an edge device.

17. The system of claim 15, wherein the first semi-supervised learning model and the second semi-supervised learning model are quantized.

18. The system of claim 15, wherein the transportation vehicle is an unmanned vehicle.

19. The system of claim 15, wherein the processing circuitry is further configured to determine a location of the at least one vehicle and associate the location of the at least one vehicle with the double parking status of the at least one vehicle.

20. The system of claim 15, wherein the processing circuitry is further configured to save the image data and the double parking status of the at least one vehicle.
